(19) United States
(12) Patent Application Publication
(10) Pub. No.: US 2018/0160243 A1
(43) Pub. Date: Jun. 7, 2018

(54) HOUSING FOR A HEARING AID AND HEARING AID HAVING A HOUSING

(71) Applicant: SIVANTOS PTE. LTD., SINGAPORE (SG)

(72) Inventor: AREND KLOSTERMEIER, KIRCHLENGERN (DE)

(21) Appl. No.: 15/728,690

(22) Filed: Oct. 10, 2017

(30) Foreign Application Priority Data
Dec. 6, 2016 (DE) 10 2016 224 282.2

(51) Int. Cl. H04R 25/00

(52) U.S. Cl. CPC H04R 25/65; H04R 2225/025

(57) ABSTRACT

A housing for a hearing aid to be inserted into an ear of a hearing aid wearer can be produced in a simpler and, in particular, more cost-effective manner than conventional housings. The housing includes a faceplate and two partial shells forming an inner chamber for accommodating hearing aid components. The partial shells have, at least in one portion, an outer contour adapted to an ear canal of the hearing aid wearer. The partial shells forming the inner chamber are produced by injection molding, and the partial shells divide the housing along an area extending parallel to an axis of the ear canal of the hearing aid wearer or diagonally to the axis of the ear canal. A hearing aid having the housing is also provided.

### CROSS-REFERENCE TO RELATED APPLICATION

This application claims the benefit, under 35 U.S.C. § 119, of German Patent Application DE 10 2016 224 282.2, filed Dec. 6, 2016; the prior application is herewith incorporated by reference in its entirety.

### BACKGROUND OF THE INVENTION

### Field of the Invention

A hearing aid is used for supplying a hearing-impaired person with acoustic environmental signals which are processed and, in particular, amplified, in order to compensate for the particular hearing impairment. For that purpose, a hearing aid usually includes an input transducer, for example in the form of a microphone, a signal processing unit including an amplifier, and an output transducer. The output transducer is generally implemented in the form of a miniature loudspeaker and is also referred to as an earphone or a receiver. It generates, in particular, acoustic output signals which are conducted to the ear of the patient and generate the desired auditory perception by the patient.

Different configurations of hearing aids are offered in order to satisfy the numerous individual needs. In the case of BTE (behind-the-ear) hearing aids, a housing including components such as a battery and the signal processing unit is worn behind the ear. Depending on the configuration, the receiver can be placed directly in the auditory canal of the wearer (so-called receiver-in-canal (RIC) hearing aids). Alternatively, the receiver is situated within the housing itself and a flexible sound tube, which is also referred to as a tube, conducts the acoustic output signals of the receiver from the housing to the auditory canal (tube hearing aids). In the case of ITE (in-the-ear) hearing aids, a housing which contains all functional components, including the microphone and the receiver, is worn at least partially in the auditory canal. CIC (completely-in-canal) hearing aids are similar to ITE hearing aids, but are worn completely in the auditory canal.

Standard shells and standard housings (so-called instant-fit ITE hearing systems), which allow for a usability that is as universal as possible, are now being utilized in the case of ITE hearing aids, in particular. In that case, the contour of the shell or the housing ideally approximately follows the auditory canal of the hearing aid wearer. In order to attain a sufficient hold in the auditory canal and ensure the desired wearing comfort, such instant-fit hearing aids are usually provided with installed elastic caps, so-called domes.

The standard housing of such an ITE hearing aid is composed of individual parts which must be produced by using different manufacturing processes. While the faceplate, i.e., the housing cover, which commonly carries the electronics system of the hearing aid, can be produced by injection molding, the housing shells of ITE hearing aids are usually produced in the laboratory or by using a 3D printing method (e.g., SDL: selective deposition lamination). The faceplate is then fastened on the housing shell and is adapted to the contour of the shell. In that case, the shell production is complex and expensive, in particular, which has a negative effect, overall, on the total costs and the manufacturing process of an ITE hearing aid.

### SUMMARY OF THE INVENTION

It is accordingly an object of the invention to provide a housing for a hearing aid and a hearing aid having a housing, which overcome the hereinafore-mentioned disadvantages of the heretofore-known devices of this general type and which provide a possibility of producing an ITE hearing aid to be simpler and, in particular, more cost effective.

With the foregoing and other objects in view there is provided, in accordance with the invention, a housing for a hearing aid which can be inserted into the ear of a hearing aid wearer. The housing comprises two partial shells which form an inner chamber for accommodating hearing aid components and have, at least in one portion, an outer contour adapted to an ear canal of the hearing aid wearer, and, additionally, a faceplate. The partial shells forming the inner chamber are produced by injection molding, and the partial shells divide the housing along an area extending parallel to the axis of the ear canal of the hearing aid wearer or diagonally to the axis of the ear canal.

The two partial shells form the housing shell of the hearing aid housing in this case. Due to the division of the housing or even the housing shell along an area extending parallel to the axis of the ear canal of the hearing aid wearer or diagonally to the axis of the ear canal and, therefore, due to the formation of the housing shell from two partial shells, it is possible to cost-effectively produce the two partial shells by injection molding. In the case, in particular, of a division extending parallel to the axis of the ear canal of the hearing aid wearer, the partial shells can be easily removed from a mold, and therefore production by injection molding is possible. An area extending diagonally with respect to the axis of the ear canal, i.e., a division implemented at an acute angle, also enables removal from the mold and, therefore, the production of the housing or the two housing shells by injection molding. In this way, the production costs for an ITE hearing aid can be substantially reduced as compared to production methods utilized so far.

The partial shells form a common inner chamber, in which hearing aid components such as a microphone, a signal processing unit, and further electronic components are situated. Both partial shells include, at least in one portion, an outer contour adapted to an ear canal of the hearing aid wearer, and therefore the housing adapts to the contour of the ear canal when inserted therein and provides the hearing aid wearer with a correspondingly comfortable wearing sensation. The (generally curved) axis of the ear canal also forms an axis of the housing, in particular, in this case.

In one advantageous embodiment of the invention, the partial shells are detachably fastened to each other and form the inner chamber. In this way, damaged components can be replaced, for example, when repair is carried out or in the case of a damage event, and the partial shells can be subsequently fastened to each other again. The partial shells can be non-destructively separated from each other in this case and the housing can therefore be opened.

In particular, the partial shells are joined to each other by pins and form the inner chamber. For this purpose, narrow pins are preferably utilized, which take up little installation space and can be easily removed again by using a corresponding tool in the event of a desired separation of the two partial shells.

The housing advantageously additionally includes a faceplate. The faceplate closes the housing shell formed from the two partial shells and, together with the two partial shells, forms the housing of the hearing aid. The faceplate is advantageously prefabricated, as a separate component, independently of the partial shells, preferably also by an injection molding process. Therefore, only one production method needs to be used in order to produce the housing. The faceplate is advantageously equipped with standard components such as microphones, battery contacts, inductive antennas, and the like. In addition, the faceplate can be constructed to include actuating elements, such as small rotary wheels or switches, which make it possible to operate the hearing aid (for example, by changing a hearing program). The faceplate and the partial shells are preferably snapped together and form a closed housing.

In one preferred embodiment of the invention, the faceplate is integrally formed with at least one partial shell. In this case, the faceplate is therefore not a separate component, but rather part of the at least one partial shell. In other words, the faceplate is produced as one part with at least one partial shell.

Advantageously, at least the partial shells forming the inner chamber for accommodating hearing aid components can be positioned in the ear canal of a hearing aid wearer. This is the case, in particular, with “classic” ITE hearing aids. In this case, the housing shell is inserted in the ear canal, while the faceplate can be seen and felt from the outside. In the case of a CIC hearing aid, which is worn completely in the auditory canal, the faceplate is also positioned in the ear canal of a hearing aid wearer and is therefore no longer visible from the outside.

With the objects of the invention in view, there is concomitantly provided a hearing aid being insertable into the ear of a hearing aid wearer. The hearing aid comprises a housing, at least one microphone, a signal processing unit including an amplifier and a receiver, and further electronic and functional components. The particular components are preferably situated within the housing and/or are components of the housing. The hearing aid is preferably constructed as an ITE hearing aid. Alternatively preferably, the hearing aid is constructed as a CIC hearing aid.

The dependent claims directed to the housing, and the advantages indicated therefor, can be correspondingly transferred to the hearing aid.

Other features which are considered as characteristic for the invention are set forth in the appended claims.

Although the invention is illustrated and described herein as embodied in a housing for a hearing aid and a hearing aid having a housing, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, perspective view of a housing as part of an ITE hearing aid, which includes two partial shells fastened to each other and a faceplate to be fastened on the housing;

FIG. 2 is a fragmentary, perspective view of an inner side of the two partial shells of the housing according to FIG. 1; and

FIG. 3 is a fragmentary, perspective view of outer sides of the two partial shells of the housing according to FIG. 1.

### DETAILED DESCRIPTION OF THE INVENTION

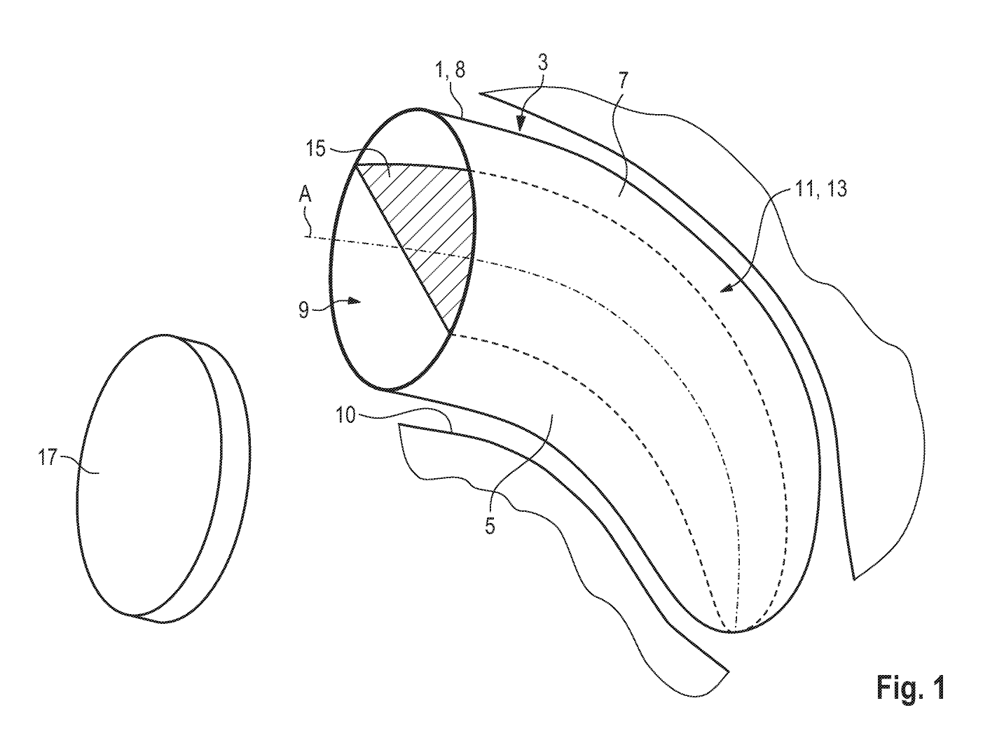

Referring now in detail to the figures of the drawings, in which parts and sizes that are the same are always labeled with the same reference numerals, and first, particularly, to FIG. 1 thereof, there is seen a housing 1 for a hearing aid 3 that can be inserted into the ear of a hearing aid wearer. The housing 1 of the hearing aid 3 includes two partial shells 5, 7 which form a housing shell 8 of the housing 1 and, together, enclose an inner chamber 9 for accommodating non-illustrated hearing aid components. The present embodiment is a classic ITE hearing aid 3, in which the partial shells 5, 7 are positioned in the ear canal 10 of the hearing aid wearer. The partial shells 5, 7 each have, in a portion 11, an outer contour 13 which has been adapted to an ear canal 10 of the hearing aid wearer and provides for a comfortable fit of the hearing aid 3.

In the present embodiment, the partial shells 5, 7 divide the housing 1 along an area 15 extending in parallel to an axis A of the ear canal 10 of the hearing aid wearer. This division makes it possible to remove the two partial shells 5, 7 from a mold and therefore opens up the possibility of simply and cost-effectively producing the partial shells by injection molding. A division of the housing 1 along an area extending diagonally with respect to the axis A of the ear canal 10 of the hearing aid wearer is also possible, of course. The partial shells 5, 7 are detachably fastened to each other and form the inner chamber 9. For this purpose, non-illustrated pins are utilized, which allow for a simple fastening to one another and make it possible to non-destructively open the housing shell 8 by separating the partial shells 5, 7.

The housing also includes a faceplate 17 which is also produced as a separate component by injection molding. Alternatively, an integral production of the faceplate 17 with at least one of the two partial shells 5, 7 is also possible.

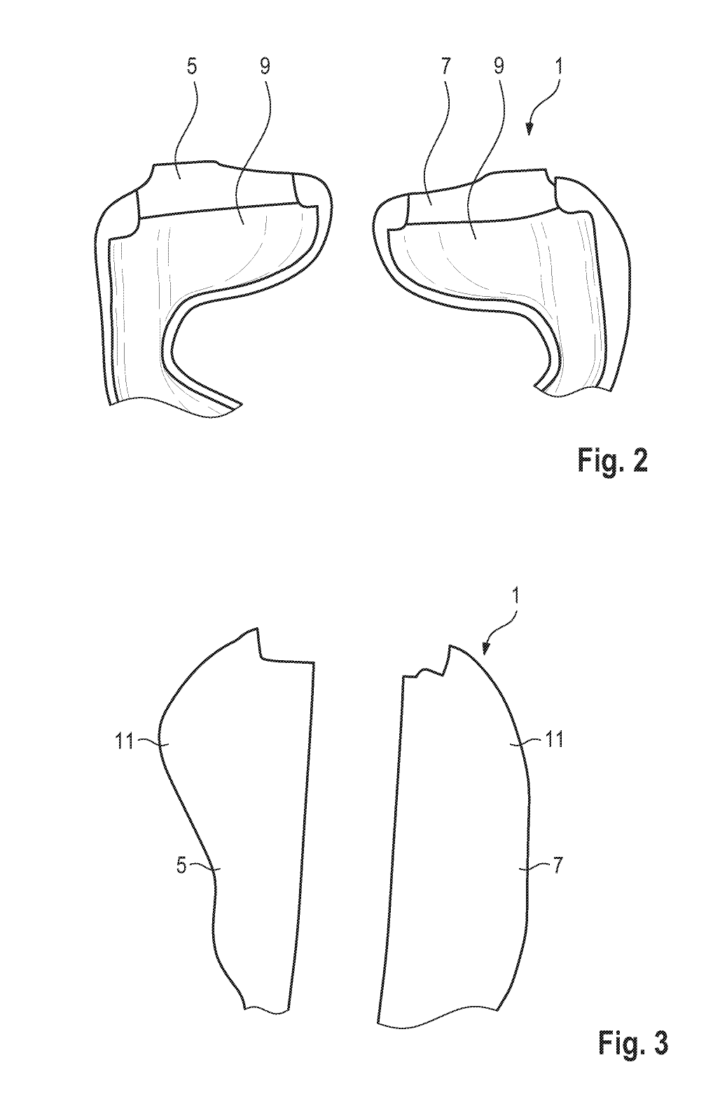

The partial shells 5, 7 are shown separately in each of FIGS. 2 and 3. The inner chamber 9, which has been removed from the mold and is provided for accommodating hearing aid components, is visible in FIG. 2. FIG. 3 shows the outer contour 13 which has been adapted to the ear canal 10 of the hearing aid wearer, at least in the portion 11.

The invention becomes particularly clear on the basis of the above-described exemplary embodiments, although it is not limited to these exemplary embodiments. Rather, further embodiments of the invention can be derived from the claims, and the description presented above.

1. A housing for a hearing aid to be inserted into an ear of a hearing aid wearer, the housing comprising:
a faceplate; and
two injection-molded partial shells forming an inner chamber for accommodating hearing aid components;
said partial shells including at least one portion having an outer contour adapted to an ear canal of the hearing aid wearer; and
said partial shells dividing the housing along an area extending parallel to an axis of the ear canal of the hearing aid wearer or diagonally to the axis of the ear canal.

2. The housing according to claim 1, wherein said partial shells are detachably fastened to each other to form said inner chamber.

3. The housing according to claim 1, wherein said partial shells are configured to be joined to each other by pins.

4. The housing according to claim 1, wherein said faceplate is formed integrally or in one piece with at least one of said partial shells.

5. The housing according to claim 1, wherein at least said partial shells are dimensioned to be positioned in the ear canal of the hearing aid wearer.

6. A hearing aid to be inserted into an ear of a hearing aid wearer, the hearing aid comprising a housing according to claim 1.
